(19) United States
(12) Patent Application Publication
(10) Pub. No.: US 2011/0103629 A1
(43) Pub. Date: May 5, 2011

(54) WAX RESISTANT EARPIECE TIP

(76) Inventors: Walter P. Sjursen, West Windsor, NJ (US); Hassan A. Mohamed, Bayonne, NJ (US)

(21) Appl. No.: 12/938,181

(22) Filed: Nov. 2, 2010

Related U.S. Application Data
(60) Provisional application No. 61/257,585, filed on Nov. 3, 2009.

(51) Int. Cl. H04R 25/00

(52) U.S. Cl. 381/325

(57) ABSTRACT

A wax-resistant earpiece tip has one or more sound openings and a torturous path to inhibit wax from reaching a receiver mountable therein. The tip may further include a folded acoustical horn. A chamber may be formed in the tip to collect debris. The tip may include a stop bar to prevent the tip from collapsing against a receiver sound port.

### RELATED APPLICATION

This application claims the benefit of U.S. Provisional Application No. 61/257,585, filed on Nov. 3, 2009. The entire teachings of the above application are incorporated herein by reference.

### BACKGROUND

Cerumen (ear wax) has been a long-standing problem with hearing aids and other devices that deliver sound to the ear canal through earpieces. When the cerumen clogs the sound opening(s) of the earpiece, the sound is blocked and does not reach the ear drum. The user then thinks the device has failed.

### SUMMARY

Embodiments of an earpiece tip disclosed herein provide improved resistance to clogging that is due to wax or other debris.

A wax-resistant earpiece tip has one or more sound openings and a torturous path to inhibit wax from reaching a receiver mountable therein. The tip may be formed from an elastomer material such as silicone and may be colored or clear in color. The tip may further include a folded acoustical horn. The sound openings may be of any shape including circular, rectangular, and slotted. A chamber may be formed in the tip to collect debris.

The tip may include a stop bar to prevent the tip from collapsing against a receiver sound port. The stop bar may have a higher durometer than the remainder of the tip and may be integrally molded with the tip or made as a separate piece and attached to the tip. The stop bar may be attached to the tip by one of a press-fit, a snap-fit, or a glue attachment.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates a cross-sectional side view of an embodiment of an earpiece tip with a receiver mounted therein.

FIG. 2 illustrates a cross-sectional side view of the embodiment of FIG. 1 with the receiver removed.

FIG. 3 illustrates a side view of the tip.

FIG. 4 illustrates a bottom perspective view showing the inside of the tip.

FIG. 5 illustrates a top perspective view showing the outside of the tip.

FIG. 6A illustrates a top view of the tip.

FIG. 6B illustrates a cross-sectional side view along line A-A of FIG. 6A.

FIG. 7A illustrates another top view of the tip.

FIG. 7B illustrates a cross-sectional side view along line C-C of FIG. 7A.

### DETAILED DESCRIPTION

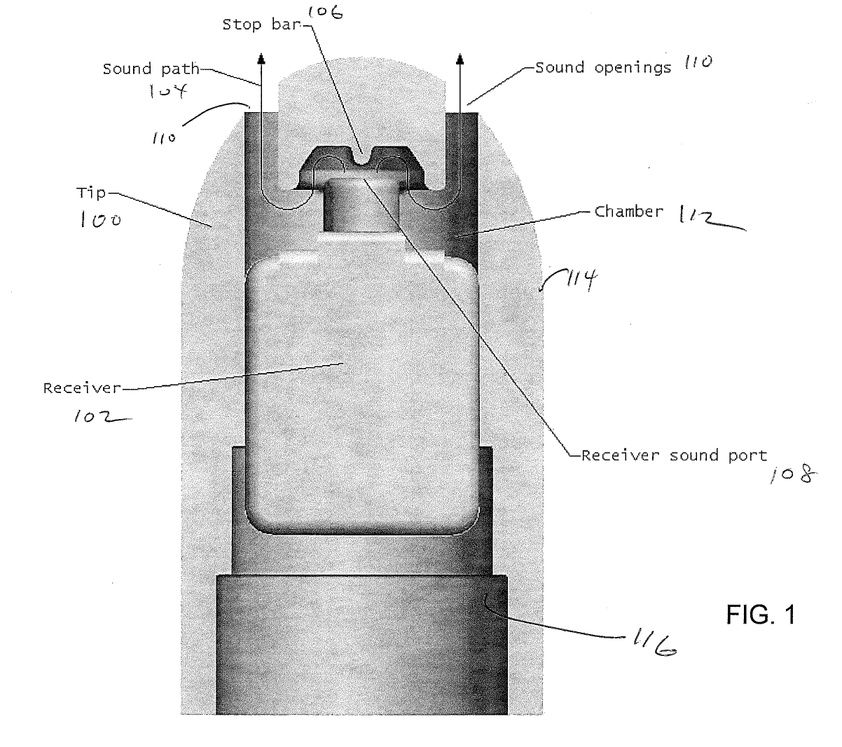

FIGS. 1-5, 6A-6B, 7A-7B illustrate an embodiment of a wax resistant earpiece tip. The tip provides improved resistance to clogging that is due to wax or other debris. The embodiment shown may be used with earpieces in devices such as hearing instruments or headsets that deliver sound to the ear canal of a user.

The tip may be made from an elastomer. Silicone is a preferred material as cerumen does not tend to stick well to silicone. Other materials may be used. The durometer of the tip material is generally low, in the range of 10 to 30 (Shore A scale), but materials with other durometers may be used.

The cross-sectional side view of FIG. 1 shows an example earpiece tip 100 with a receiver 102 mounted therein. The receiver 102 is mounted to fit in an upper portion of a graduated bore section 116. A sound path 104 through sound openings 110 in an upper portion of the tip forms a folded acoustical horn. The dimensions are chosen to provide little attenuation of the sound coming out of the receiver. The dimensions and material properties may be chosen such that a resonance is obtained that can further amplify the sound. A stop bar 106 is provided in front of the receiver sound port 108 to minimize blocking of the receiver sound port if the tip is pushed in, for example when the tip is inserted into the ear canal. The stop bar is optional. The folded acoustical horn formed between the receiver sound port 108 and the sound openings 110 of the tip also provides a chamber 112 in which debris, such as cerumen, may be trapped.

The stop bar 106 may be integral to the tip, or may be a separate part. The stop bar may be integrally molded with the tip, but from a higher durometer material. Alternately, the stop bar may be made as a separate piece and attached to the tip, for example by gluing or by friction fit. The separate stop bar may be made from a number of different materials, for example a thermoplastic.

The sound openings 110 of the tip are sufficiently large so as not to block sound from getting out and reaching the ear drum. One or more sound openings may be used. The openings 110 may be of any shape, for example circular, rectangular, or slotted. In the preferred embodiment, the sound openings are slotted. The slot shape is preferred as it provides easy access for the user to clean cerumen from the sound openings and chamber. A simple wax removal tool, for example consisting of a small loop of wire, can be inserted into the slot to scoop the cerumen out.

The color of the tip material may be selected from a number of different colors, or may even be multi-colored. The tips may be color-coded, for example using the standard scheme of red for the right ear and blue for the left ear. In the preferred embodiment, the tip material is selected to be clear to allow the user to easily see the amount of cerumen contained in the chamber.

As shown in FIG. 1, sound from the receiver sound port 108 travels up from the receiver 102, around and down into the chamber 112, then back up and out the sound opening 110 of the tip to reach the ear drum. There is no direct path from the receiver sound port to the outside surface 114 of the tip.

The path for cerumen to reach the receiver sound port is also torturous. Cerumen that enters the sound openings 110 of the tip must travel down into the chamber 112, then back up past the stop bar 106 and finally into the receiver sound port 108. The cerumen generally becomes lodged in the chamber 112 and never reaches the receiver sound port 108.

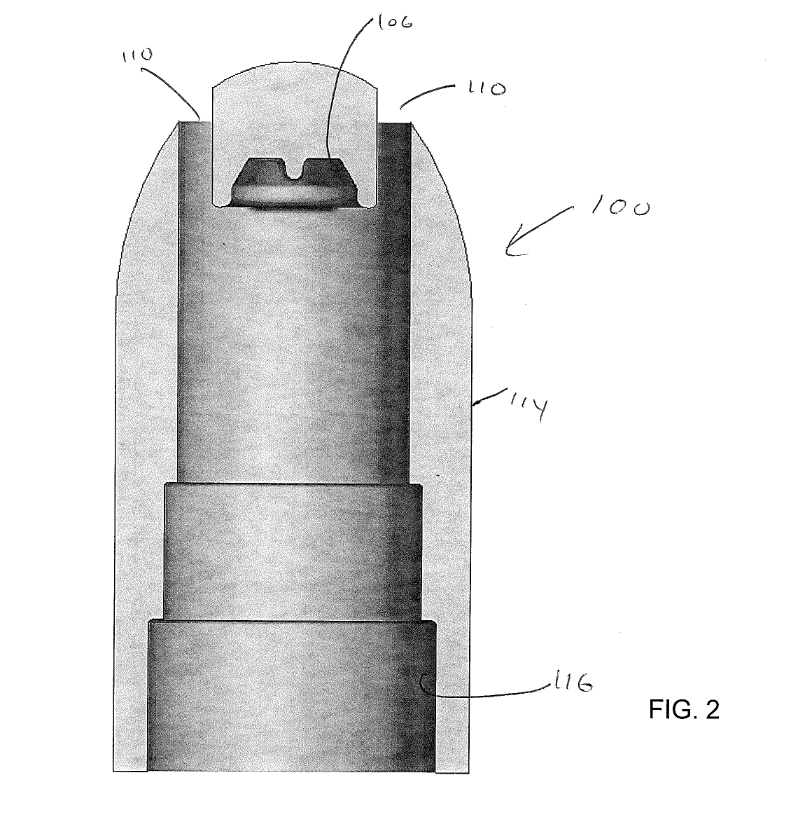

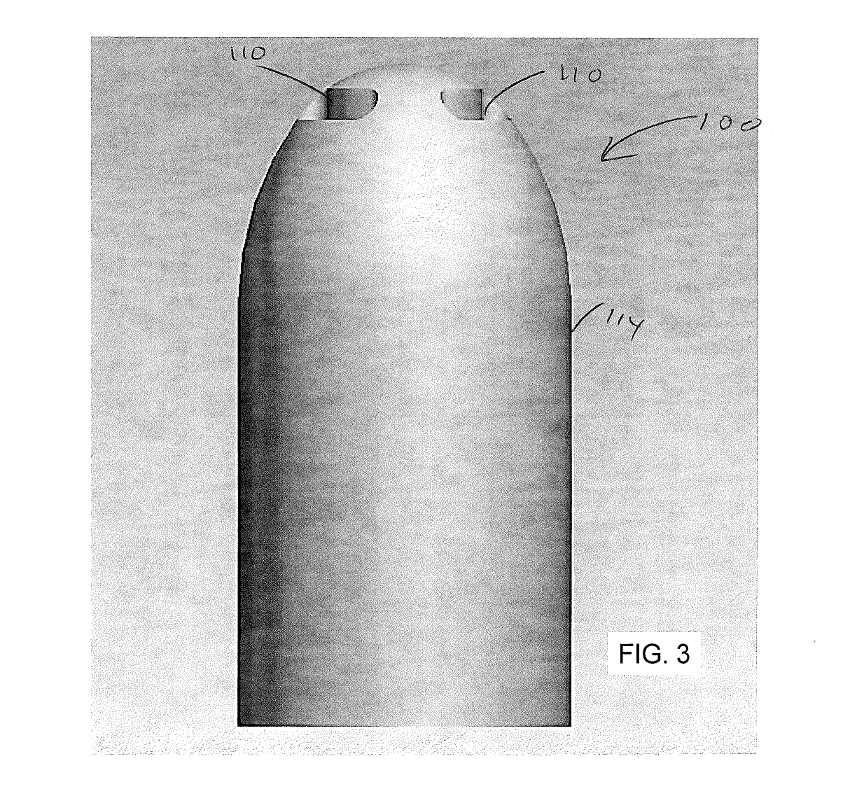

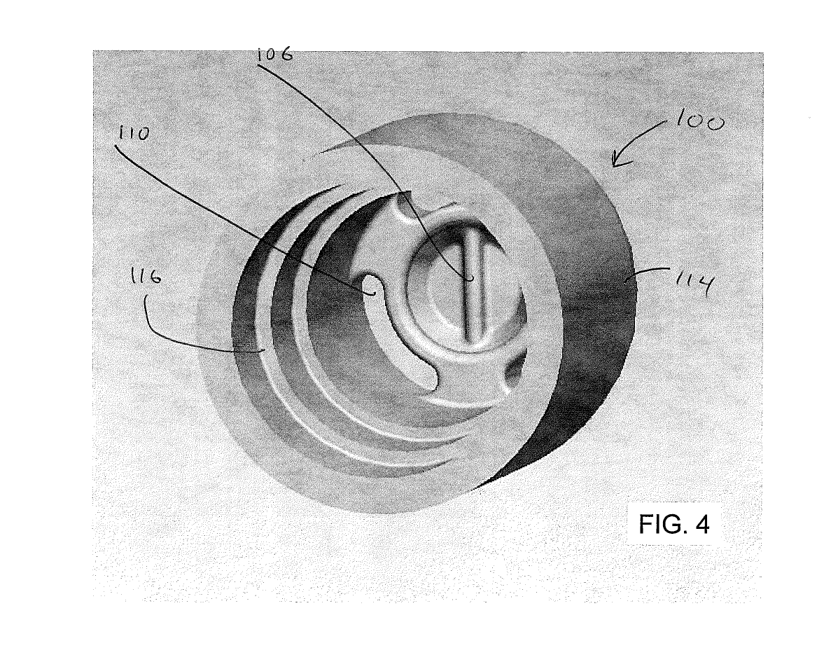

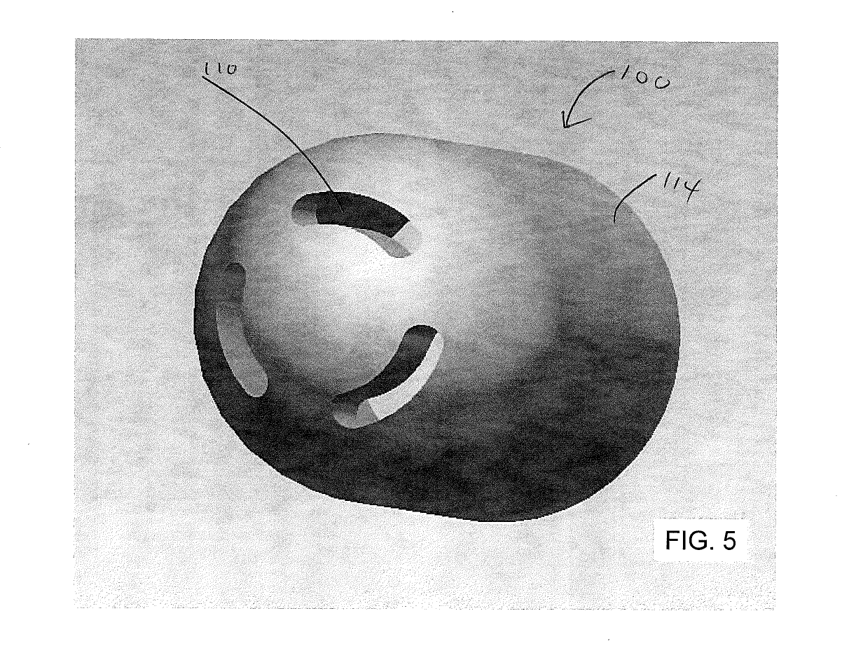

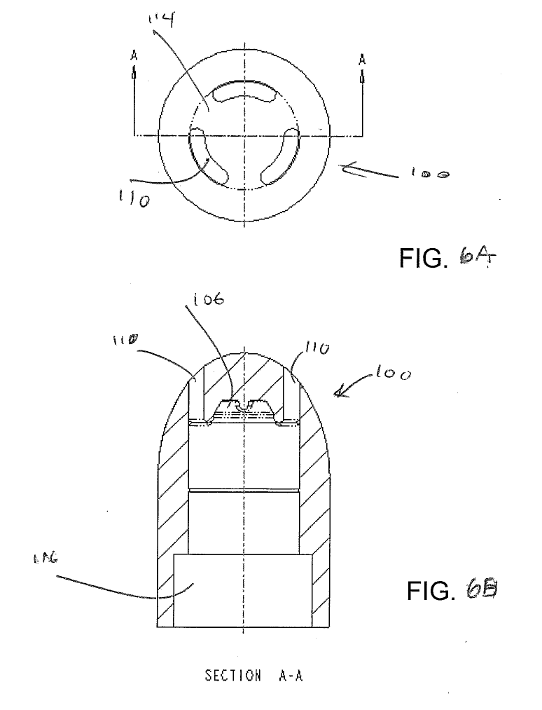

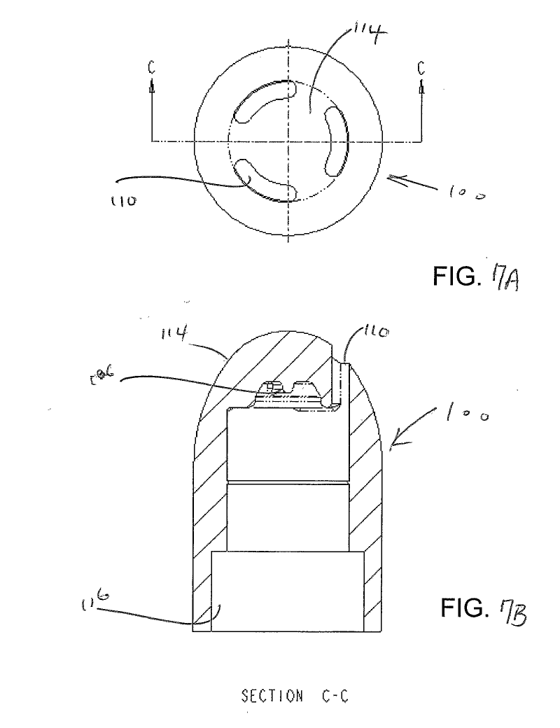

FIG. 2 illustrates a cross-sectional side view of the embodiment of FIG. 1 with the receiver removed. FIG. 3 illustrates a side view of the tip. FIG. 4 illustrates a bottom perspective view showing the inside of the tip and the underside of the stop bar 106 and the graduated bore section 116. FIG. 5 illustrates a top perspective view showing the outside of the tip. FIG. 6A illustrates a top view of the tip. FIG. 6B illustrates a cross-sectional side view along line A-A of FIG. 6A. FIG. 7A illustrates another top view of the tip. FIG. 7B illustrates a cross-sectional side view along line C-C of FIG. 7A.

The dimensions of the tip, including the sound path dimensions, the material properties, such as young's modulus, density and damping parameters, define a complex mechanical spring-mass system that may be adjusted to create or reduce resonances and thereby affect the acoustical properties of the receiver-tip combination with the ear canal.

While this invention has been particularly shown and described with references to example embodiments thereof, it will be understood by those skilled in the art that various changes in form and details may be made therein without departing from the scope of the invention encompassed by the appended claims.

What is claimed is:

1. A wax-resistant earpiece tip having one or more sound openings and a torturous path to inhibit wax from reaching a receiver mountable therein.

2. The tip of claim 1 comprising an elastomer material.

3. The tip of claim 2 in which the elastomer material is silicone.

4. The tip of claim 2 in which the elastomer material is clear in color.

5. The tip of claim 1 further comprising a folded acoustical horn.

6. The tip of claim 1 in which the sound openings are shaped as slots.

7. The tip of claim 1 further comprising a chamber to collect debris.

8. The tip of claim 1 further comprising a stop bar to prevent the tip from collapsing against a receiver sound port.

9. The tip of claim 8 in which the stop bar has a higher durometer than the remainder of the tip and is integrally molded with the tip.

10. The tip of claim 8 in which the stop bar is made as a separate piece and attached to the tip.

11. The tip of claim 10 in which the stop bar is attached to the tip by one of a press-fit, a snap-fit, or a glue attachment.

12. The tip of claim 10 in which the stop bar is of a higher durometer material compared to the tip material.

13. The tip of claim 1 in which the sound openings are any of circular, rectangular, and slotted.

14. The tip of claim 1 in which the tip material is colored.
